(19) United States
(12) Patent Application Publication
(10) Pub. No.: US 2006/0219699 A1
(43) Pub. Date: Oct. 5, 2006

(54) Method for adjusting the temperature of a motor vehicle seat

(75) Inventors: Thomas Geisel, Rottenburg (DE); Achim Gottmann, Renningen (DE); Vasilios Orizaris, Renningen (DE); Karl Pfahler, Stuttgart (DE); Lothar Renner, Nufringen (DE); Bernd Schmidt, Wildberg (DE); Dietmar Zwoelfer, Hildrizhausen (DE)

Correspondence Address: KENYON & KENYON LLP, ONE BROADWAY, NEW YORK, NY, 10004, US

(73) Assignee: DAIMLERCHRYSLER AG

(21) Appl. No.: 10/542,101

(22) PCT Filed: Nov. 25, 2003
(86) PCT No.: PCT/EP03/13217

§ 371 Date: Mar. 13, 2006

(30) Foreign Application Priority Data
Jan. 10, 2003 (DE) 103 00 570.6

(51) Int. Cl. H05B 1/02

(52) U.S. Cl. 219/497

(57) ABSTRACT

In a method for adjusting the temperature of a motor vehicle seat, which includes a seat ventilating system and a seat heater, to a predetermined desired value, in which the temperature of the seat is detected in the region of a seat surface by a first temperature sensor and the outside temperature is detected by a second temperature sensor, the seat ventilating system is switched off below a first temperature threshold for the outside temperature, and the seat heater is switched off above a second temperature threshold for the outside temperature. By these measures, an occupant may be provided with a comfortable micro-climate in the seat region for his/her well-being.

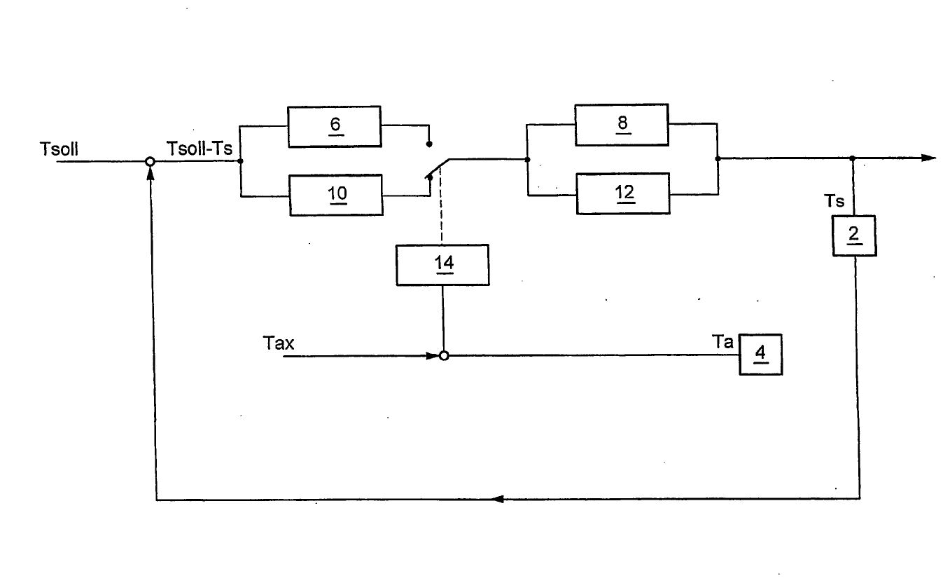

### FIELD OF THE INVENTION

The present invention relates to a method for adjusting the temperature of a motor vehicle seat.

### BACKGROUND INFORMATION

An aspect of designing a vehicle interior is to provide the occupant of a motor vehicle with optimum seating comfort. Special attention is directed here to the thermo-physiological comfort by regulating the transportation of heat and moisture. No other component of the motor vehicle is in contact over such a large surface area and consistently with the occupant as the motor vehicle seat. Accordingly, a healthy and comfortable micro-climate is important between the seat surface and the occupant, this micro-climate having a positive effect on the mental and physical fitness of the occupant.

German Published Patent Application No. 198 51 979 describes a vehicle seat, in which, in order to set a comfortable seat climate, a control unit is provided which is connected on the input side to a temperature sensor for recording the temperature of the seat surface, the “integral sensor”, and a moisture sensor, and is also connected on the output side to electric switching circuits of a seat heater and seat ventilating system. The control unit is additionally connected on the input side by an outside temperature sensor for measuring the ambient temperature. A temperature adjusting system is integrated in the control unit and adjusts the surface temperature of seat cushion and backrest cushion to a predetermined desired value by the seat heater and seat ventilating system. In this case, the desired value is corrected in the control unit as a function of the temperature value supplied by the outside sensor. The correction here can take place in such a manner that, at an outside temperature of below 20° C., the desired value is set to, for example, 36° C., and at an outside temperature of above 20° C., the desired value is lowered to, for example, 35° C. With this arrangement for influencing the temperature which is to be adjusted at the seat surface, the seat user's perception of temperature depending on the time of year is taken into account.

### SUMMARY

In an example embodiment of the present invention, a method is for adjusting the temperature of a motor vehicle seat, which includes a seat ventilating system and a seat heater, to a predetermined desired value Tdes, in which the temperature Ts of the motor vehicle seat is detected in the region of the seat surface by a first temperature sensor and the outside temperature Ta is detected by a second temperature sensor, which may ensure, for an occupant, a permanently comfortable, warm and dry micro-climate between him and the seat surface.

According to an example embodiment of the present invention, in order to adjust the temperature Ts of a seat, a seat ventilating system is switched off below a first temperature threshold Ta1 for the outside temperature Ta, and a seat heater is switched off above a second temperature threshold Ta2 for the outside temperature Ta. At low outside temperatures Ta (below the first temperature threshold Ta1 the adjusting system operates in “winter mode”), the temperature Ts of the seat is therefore set only by the seat heater and without the seat ventilating system whereas, at high outside temperatures Ta (above the second temperature threshold Ta2 the adjusting system operates in “summer mode”), the temperature Ts of the seat is set only by the seat ventilating system and without the seat heater. In the temperature interval for the outside temperature Ta between the two temperature thresholds Ta1 and Ta2, both the seat heater and the seat ventilating system may generally be used to adjust the temperature Ts of the seat. At low outside temperatures Ta when seat ventilating system and seat heater are activated in parallel by an occupant, a cool air draft may be felt at least in the upper body region. A large portion of the air fed into the motor vehicle seat by the seat ventilating system disappears from the backrest of the motor vehicle seat via the shoulder region of the occupant. The dry air supplied absorbs some of the moisture from the occupant's skin surface, resulting in an unpleasantly cool sensation for the occupant. A sensation which is perceived by the occupant as being entirely positive during summer weather conditions may be problematic at lower outside temperatures Ta. If the supply of air is constricted, the cool sensation may be perceived as being no longer so negative. During winter mode without use of the seat ventilating system, the occupant may no longer have the unpleasantly cool sensation, and the occupant may obtain an unlimited pleasant sensation. At higher outside temperatures Ta, with the seat heater and seat ventilating system operating together to adjust the temperature Ts of the seat, sweating which may be perceived as being unpleasant by the occupant starts. The best well-being for the occupant may be obtained if the seat heater is not used in the summer mode. With the present method, comfortable cushion temperatures which are in the region of the normal skin temperatures may be achieved in winter and in summer. The clothing and the skin of the occupant remain dry even under extreme climate conditions. A permanently comfortable, warm and dry micro-climate may be achieved between the seat surface and the occupant.

According to an example embodiment, the value for the first temperature threshold Ta1 is set to be equal to the value for the second temperature threshold Ta2. For example, this common value is approx. 18° C. This may make it possible to completely omit a transition region permitting a parallel use of seat heater and seat ventilating system, as a result of which the adjustment of the temperature Ts of the seat may be considerably simplified. In order to set the temperature Ts of the seat, use may be made, depending on the outside temperature Ta, in other words in summer or in winter mode, of only the seat ventilating system or the seat heater.

Example embodiments of the present invention are explained in more detail below with reference to the appended Figure.

### BRIEF DESCRIPTION OF THE DRAWING

The Figure is a schematic block circuit diagram for adjusting a temperature Ts of a motor vehicle seat having a seat ventilation system and a seat heater.

### DETAILED DESCRIPTION

As illustrated in the Figure, in a method for adjusting the temperature Ts of a motor vehicle seat to a predetermined desired value Tdes which may be set via a control device, the temperature Ts of the seat is detected in the region of a seat surface by a first temperature sensor 2 and is compared with the desired value Tdes. In addition, the outside temperature Ta is measured with a second temperature sensor 4 and is compared with a threshold value Tax for the outside temperature Ta.

The deviation Tdes-Ts between the predetermined desired value Tdes and the temperature Ts of the seat is processed by a first controller 6 for a seat heater 8 or by a second controller 10 for a seat ventilating system 12. Either the seat heater 8 is set in accordance with an output variable of the first controller 6 or the seat ventilating system 12 is set in accordance with an output variable of the second controller 10 as a function of the switching position of a switch 14 with a temperature-dependent switching function.

The temperature-dependent switching function of the switch 14 is configured such that, below a predetermined threshold value Tax for the outside temperature Ta, a “winter mode”, only the seat heater 8 is set with the adjusting system via the first controller 6. The seat ventilating system 12 is switched off in winter mode. Above the predetermined threshold value Tax for the outside temperature Ta, a “summer mode”, only the seat ventilating system 12 is set with the adjusting system via the second controller 10. The seat heater 8 is switched off in summer mode. A temperature value of approximately 18° C. may correspond to the threshold value Tax. A delimitation between winter and summer mode at this threshold value Tax for the outside temperature Ta may be perceived as being particularly pleasant by occupants. The threshold value Tax may be varied as a function of individual perception. Furthermore, by deactivating the adjusting system, a manual actuation of seat heater 8 and seat ventilating system 12 may be ensured.

In an exemplary embodiment, the threshold value Tax for the outside temperature Ta is divided into a first temperature threshold Ta1 and a second temperature threshold Ta2 with Ta1 smaller than Ta2. The seat ventilating system 12 is switched off below the first temperature threshold Ta1, and the seat heater 8 is switched off above the second temperature threshold Ta2. The winter and summer mode is separated by the temperature interval between the two temperature thresholds Ta1 and Ta2 in which a mixed mode is possible. In the temperature interval, seat heater 8 and seat ventilating system 12 may be used in parallel for adjusting the temperature Ts of the seat in order to improve the seating comfort for the occupants. However, an individual operation of seat heater 8 and seat ventilating system 12 is also possible in this temperature interval bounded by the temperature thresholds Ta1 and Ta2.

In the exemplary embodiment illustrated in the Figure, the value for the first temperature threshold Ta1 is therefore selected to be equal to the value for the second temperature threshold Ta2 as a special case.

The predetermined desired value Tdes for the temperature Ts of the seat has a value in the temperature range between 32.5° C. and 35.5° C. which may correspond to the individual well-being of the occupant and may be set individually. Irrespective of the outside temperature Ta, occupants may prefer a narrow temperature range for the temperature Ts of the seat, which they perceive as being pleasant. This may be in the given temperature range of between 32.5° C. and 35.5° C. and may be independent of summer and winter mode.

In an example embodiment of the method, the temperature Ts of the seat may be adjusted to an upper desired value Tdesu below the first temperature threshold Ta1 for the outside temperature Ta, and the temperature Ts of the seat may be adjusted to a lower desired value Tdesl above the second temperature threshold Ta2 for the outside temperature Ta, the lower desired value Tdesl being smaller than the upper desired value Tdesu. Both desired values Tdesl and Tdesu may be in the temperature range between 32.5° C. and 35.5° C. Account is therefore taken of the personal finding that in summer mode a somewhat cooler temperature Ts of the seat may be preferred than in winter, as a result of which a freshening effect may be obtained.

With the indicated method, the occupant may be provided with a comfortable micro-climate in the seat region which to the greatest possible extent may prevent unpleasant sensations in terms of feelings with regard to the thermo-physiological seating comfort.

1-5. (canceled)

6. A method for adjusting a temperature of a motor vehicle seat to at least one predetermined desired value, the motor vehicle seat including a seat ventilation system and a seat heater, comprising:
detecting the temperature of the seat in a region of a seat surface by a first temperature sensor;
detecting an outside temperature by a second temperature sensor;
switching off the seat ventilation system below a first temperature threshold for the outside temperature; and
switching off the seat heater above a second temperature threshold for the outside temperature.

7. The method according to claim 6, wherein a value for the first temperature threshold is equal to a value for the second temperature threshold.

8. The method according to claim 6, wherein the predetermined desired value for the temperature of the seat has a value between 32.5° C. and 35.5°.

9. The method according to claim 6, further comprising setting the predetermined desired value for the temperature of the seat as a function of the outside temperature.

10. The method according to claim 6, further comprising:
adjusting the temperature of the seat to an upper desired value below the first temperature threshold for the outside temperature; and
adjusting the temperature of the seat to a lower desired value above the second temperature threshold for the outside temperature, the lower desired value smaller than the upper desired value, the lower desired value and the upper desired value in a temperature range between 32.5° C. and 35.5°.
